(19) United States
(12) Patent Application Publication
(10) Pub. No.: US 2026/0077663 A1
(43) Pub. Date: Mar. 19, 2026

(54) HOLDER FOR ELECTRIC VEHICLE CHARGING CONNECTOR

(71) Applicant: Delta Electronics, Inc., Taoyuan City (TW)

(72) Inventors: I-Min Lai, Taoyuan City (TW); Ting-Ho Lu, Taoyuan City (TW); Ming-Hsien Hsieh, Taoyuan City (TW)

(21) Appl. No.: 19/265,017

(22) Filed: Jul. 10, 2025

Related U.S. Application Data
(60) Provisional application No. 63/694,779, filed on Sep. 13, 2024.

(30) Foreign Application Priority Data
Mar. 3, 2025 (CN) 202510242084.8

(51) Int. Cl. B60L 53/16

(52) U.S. Cl. CPC B60L 53/16

(57) ABSTRACT

A holder for vehicle charging connector includes a base, an accommodating space, a first engaging element and a second engaging element. The accommodating space is disposed within the base for receiving one of a first standard vehicle charging connector and a second standard vehicle charging connector. The accommodating space includes a first passage for receiving the first standard vehicle charging connector, and a second passage for receiving the second standard vehicle charging connector. The second passage is overlapped with the first passage at least in part. The first engaging element is disposed around the first passage for engaging with the first standard vehicle charging connector; and the second engaging element is disposed around the second passage for engaging with the second standard vehicle charging connector.

### CROSS-REFERENCE TO RELATED APPLICATIONS

This application claims the benefit of U.S. Provisional Application Ser. No. US 63/694,779 filed on September 13, 2024 and claims priority to China Patent Application No. 202510242084.8 filed on March 03, 2025. The entire contents of applications are incorporated herein by reference for all purposes.

### FIELD OF THE INVENTION

The present disclosure relates to a holder for vehicle charging connector, and more particularly to a holder for holding vehicle charging connectors of different standards.

### BACKGROUND OF THE INVENTION

Electric vehicles (EVs) continue to grow in popularity worldwide, and the charging thereof becomes an important issue.

EV charging connectors might be varied by country and/or the type of EV, and each kind of EV charging connector has unique feature. Currently, in the charging station, one kind of holder only matches with one kind of vehicle charging connector, and different kinds of holders have to be set for placing vehicle charging connectors of different standards. For example, each of the current standard vehicle charging connectors, such as, Type 1, Type 2, CCS, NACS, CHAdeMO and GB/T, has a unique structure, and the holding structure of the holder therefor is varied accordingly.

Therefore, there is a need of providing a holder for vehicle charging connector capable of adapting to vehicle charging connectors of different standards.

### SUMMARY OF THE INVENTION

An object of the present disclosure is to provide a holder for vehicle charging connector which is capable of accommodating and fixing vehicle charging connectors of different standards with different contours.

In accordance with an aspect of the present disclosure, a holder for vehicle charging connector is provided. The holder includes a base, an accommodating space, a first engaging element and a second engaging element. The accommodating space is disposed within the base for receiving one of a first standard vehicle charging connector and a second standard vehicle charging connector. The accommodating space includes a first passage for receiving the first standard vehicle charging connector, and a second passage for receiving the second standard vehicle charging connector. The second passage is overlapped with the first passage at least in part. The first engaging element is disposed around the first passage for engaging with the first standard vehicle charging connector; and the second engaging element is disposed around the second passage for engaging with the second standard vehicle charging connector.

In an embodiment, the first passage and the second passage have a same entrance.

In an embodiment, the accommodating space includes a first inner surface and a second inner surface, the first inner surface defines at least one portion of the first passage, and the second inner surface defines at least one portion of the second passage.

In an embodiment, at least one portion of the first inner surface mechanically interferes with the first standard vehicle charging connector, and at least one portion of the second inner surface mechanically interferes with the second standard vehicle charging connector.

In an embodiment, a step is formed at an intersection between the first inner surface and the second inner surface, and the step defines a length of the second passage parallel to a longitudinal direction thereof.

In an embodiment, the first standard vehicle charging connector includes a first engaging portion, and the first engaging element is extended into the first passage for engaging with the first engaging portion.

In an embodiment, further including a supporting element disposed in the first passage and opposite to the first engaging element for pressing against the first standard vehicle charging connector.

In an embodiment, further including a receiving space disposed within the base and adjacent to the accommodating space, wherein the second standard vehicle charging connector includes a second engaging portion extended outwardly, and the second engaging portion is disposed in the receiving space when the second standard vehicle charging connector enters the second passage.

In an embodiment, the second engaging element is extended into the receiving space for engaging with the second engaging portion.

In an embodiment, the second standard vehicle charging connector includes a cover located on a top of the second engaging portion, and a sectional area of the receiving space perpendicular to a longitudinal direction of the second passage is approximately identical to a contour of the cover.

In accordance with another aspect of the present disclosure, a holder for vehicle charging connector is provided. The holder includes a base, an accommodating space and a plurality of engaging elements. The accommodating space is disposed within the base for receiving vehicle charging connectors of a plurality of standards. The accommodating space includes a plurality of passages, wherein each of the plurality of passages receives one corresponding vehicle charging connector of the vehicle charging connector of the plurality of standards, and the plurality of passages are overlapped at least in part. Each of the plurality of engaging elements is disposed around one corresponding passage of the plurality of passages for engaging with one corresponding vehicle charging connector of the vehicle charging connectors of the plurality of standards received in the corresponding passage.

In an embodiment, the plurality of passages have a same entrance.

The holder for vehicle charging connector of the present disclosure provides a solution capable of commonly accommodating vehicle charging connectors of different standards in one single structure design through disposing plural passages, which are partially overlapped and shave one entrance, thereby effectively reducing the cost and space for setting new holder.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a schematic view showing a holder for vehicle charging connector according to an embodiment of the present disclosure;

FIG. 2 is a front view showing an accommodating space of the holder according to an embodiment of the present disclosure;

FIG. 3 a schematic view showing the accommodating space of the holder according to the embodiment of the present disclosure;

FIG. 4 is a sectional view showing the accommodating space of the holder according to the embodiment of the present disclosure;

FIG. 5A is a schematic view showing a combination of a first kind of vehicle charging connector and the accommodating space according to the embodiment of the present disclosure;

FIG. 5B is a sectional view showing the combination of the first kind of vehicle charging connector and the accommodating space according to the embodiment of the present disclosure;

FIG. 6A is a schematic view showing a combination of a second kind of vehicle charging connector and the accommodating space according to the embodiment of the present disclosure; and

FIG. 6B is a sectional view showing the combination of the second kind of vehicle charging connector and the accommodating space according to the embodiment of the present disclosure.

### DETAILED DESCRIPTION OF EMBODIMENTS

The present disclosure will now be described more specifically with reference to the following embodiments. It is to be noted that the following descriptions of embodiments of this disclosure are presented herein for purpose of illustration and description only. It is not intended to be exhaustive or to be limited to the precise form disclosed.

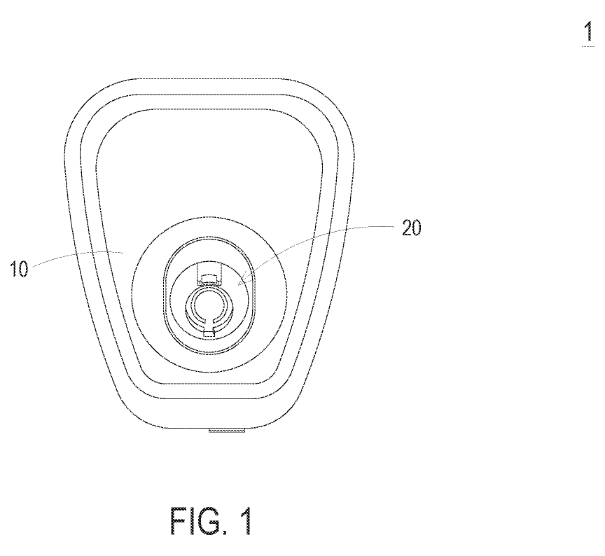

Please refer to FIG. 1 which is a schematic view showing a holder for vehicle charging connector according to an embodiment of the present disclosure. The holder 1 for vehicle charging connector includes a base 10 and an accommodating space 20 disposed within the base 10. The base 10 is usually mounted on a wall or disposed on a standing pole, and the accommodating space 20 is used to receive a vehicle charging connector, which is connected to a socket outlet via a cable.

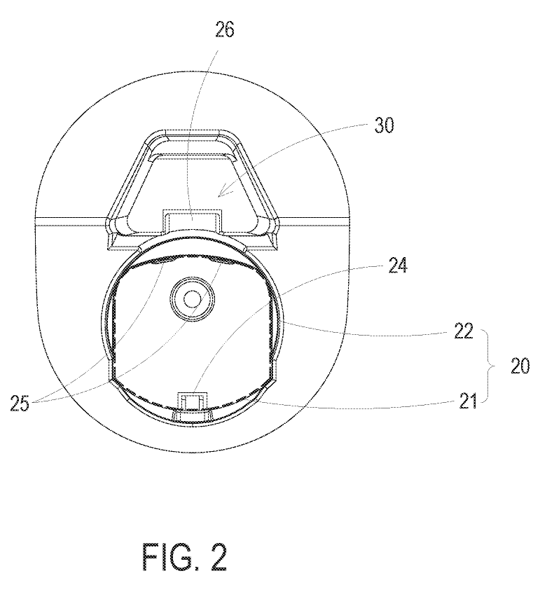

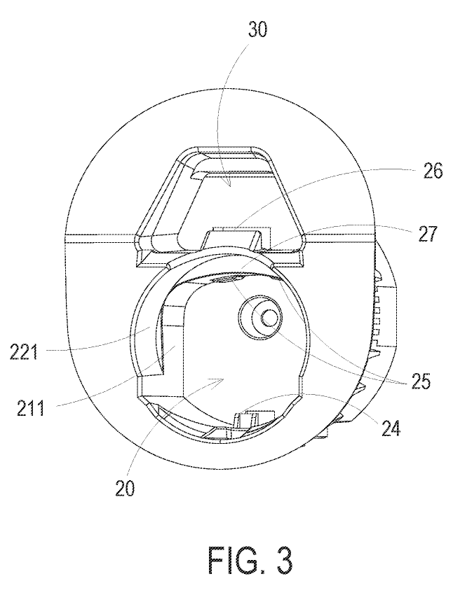

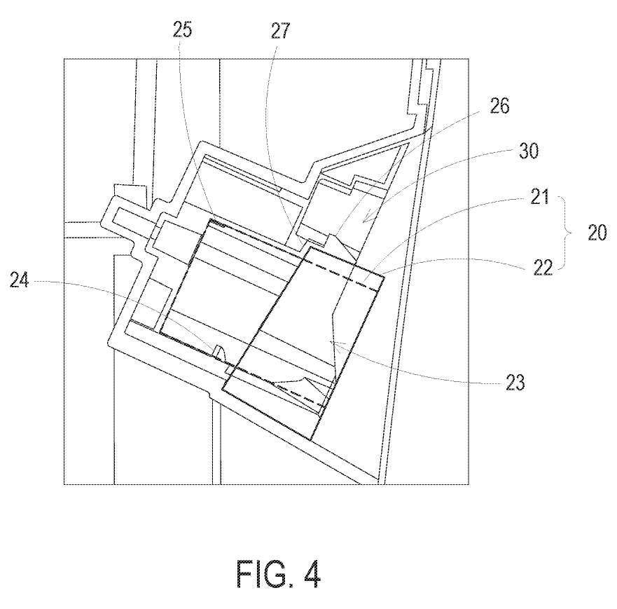

Please refer to FIG. 2 to FIG. 4. FIG. 2 is a front view showing the accommodating space of the holder according to an embodiment of the present disclosure, FIG. 3 a schematic view showing the accommodating space of the holder according to the embodiment of the present disclosure, and FIG. 4 is a sectional view showing the accommodating space according to the embodiment of the present disclosure. The accommodating space 20 includes a first passage 21 and a second passage 22. The first passage 21 is used to receive a first standard vehicle charging connector, such as one charging connector selected from standards of Type 1, Type 2, CCS, NACS, CHAdeMO and GB/T, and the second passage 22 is used to receive a second standard vehicle charging connector, such as another charging connector selected from standards of Type 1, Type 2, CCS, NACS, CHAdeMO and GB/T. Particularly, the first passage 21 and the second passage 22 share the same entrance 23, and the first passage 21 and the second passage 22 are at least partially overlapped.

In the present disclosure, on one hand, a portion of the inner surface of the accommodating space 20 is formed to approximately match to at least one portion of the contour of the first standard vehicle charging connector, and this portion of inner surface becomes a portion of the first passage 21; on the other hand, another portion of the inner surface of the accommodating space 20 is formed to approximately match to at least one portion of the contour of the second standard vehicle charging connector, and this another portion of inner surface becomes a portion of the second passage 22. Under this configuration, through the mechanical interferences respectively between the different portions of the inner surface of the accommodating space 20 and the contours of corresponding vehicle charging connectors, vehicle charging connectors of different standards can be rested in the same accommodating space 20 through using the corresponding passages, and thus, the accommodating space 20 with one single structure design and one single entrance 23 is capable of covering the holding usages of vehicle charging connectors of at least two standards.

Accordingly, through employing the holder 1 for vehicle charging connector of the present disclosure, the cost and space for establishing another charging station and/or setting another holder can be saved. For example, a possible situation is when the user changes from one car using the first charging standard to another car using the second charging standard. In this situation, for saving the cost and space, the user usually will assemble the original vehicle charging connector of the first standard with the adaptor to change to the new vehicle charging connector of the second standard, and through employing the holder 1 for vehicle charging connector of the present disclosure, the new vehicle charging connector can be directly accommodated in the original holder without setting another holder. Another possible situation is the user who owns different cars of different charging standards uses the adaptor(s) to switch among vehicle charging connectors of different standards for sharing the same socket outlet. c

In the accommodating space 20, a portion of the first passage 21 is defined by a first inner surface 211, which correspondingly interferes with at least one portion of the contour of the first standard vehicle charging connector; and a portion of the second passage 22 is defined by a second inner surface 221, which correspondingly interferes with at least one portion of the contour of the second standard vehicle charging connector. The first passage 21 and the second passage 22 share an overlapped space near the entrance 23, and additional spaces respectively required for respective vehicle charging connectors are developed around the overlapped space, thereby commonly defining the accommodating space 20. For example, in the embodiment shown in FIG. 2 to FIG. 4, compared with the second standard vehicle charging connector, the length of the first standard vehicle charging connector parallel to the longitudinal direction thereof is longer and the sectional area perpendicular to the longitudinal direction thereof is smaller, so that, as shown in FIG. 3 and FIG. 4, the second inner surface 221 is disposed near the entrance 23, and the first inner surface 211 is disposed at a position farther away from the entrance 23 than the second inner surface 221. Hence, as shown in FIG. 4, the first passage 21 is extended from the entrance 23 to the left side, the second passage 22 is located at the right side near the entrance 23, and the space near the entrance 23 is shared by both. Moreover, the sectional area perpendicular to the longitudinal direction of the second standard vehicle charging connector is greater than that of the first standard vehicle charging connector, so that a step 27 is formed at the intersection between the first inner surface 211 and the second inner surface 221, which therefore defines the length of the second passage 22 parallel to the longitudinal direction thereof.

More specifically, in the present disclosure, the definition of the space of each passage is that at least one portion of the space is defined by the inner surface to match to at least one portion of the contour of the corresponding vehicle charging connector, and the other portion of the space is not limited.

Notably, the defined spaces of the first passage 21 and the second passage 22 can be varied in accordance with the standards of the vehicle charging connectors that are received, and not limited thereto. For example, the vehicle charging connectors of the first standard and the second standard can be two selected from the known standards, such as Type 1, Type 2, CCS, NACS, CHAdeMO and GB/T. Furthermore, the first inner surface 211 of the first passage 21, the second inner surface 221 of the second passage 22, the lengths and sectional areas of the first passage 21 and the second passage 22 all can be varied accordingly to match to the contours of the selected connectors.

The holder 1 for vehicle charging connector further includes a first engaging element 24 and a second engaging element 26 for respectively restricting movements of the first standard vehicle charging connector and the second standard vehicle charging connector in the accommodating space 20. That is, through the engagement between the first standard vehicle charging connector and the first engaging element 24, the first standard vehicle charging connector is positioned in the first passage 21, and through the engagement between the second standard vehicle charging connector and the second engaging element 26, the second standard vehicle charging connector is positioned in the second passage 22. The mechanical engagements are utilized to avoid the vehicle charging connectors from detaching from the base 10. For example, the engaging element can be disposed in, around or close to the passage to have a mechanical engagement with a portion of the corresponding vehicle charging connector, so as to ensure the positioning of said vehicle charging connector in the passage.

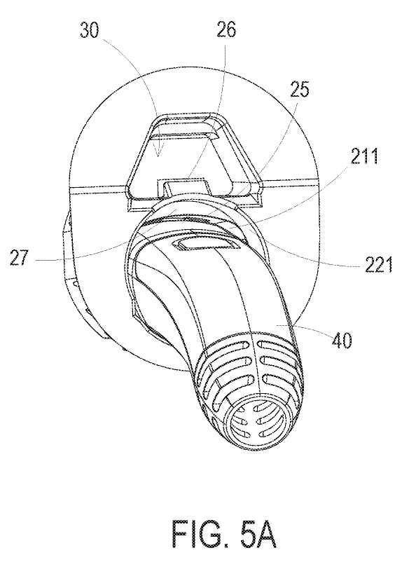

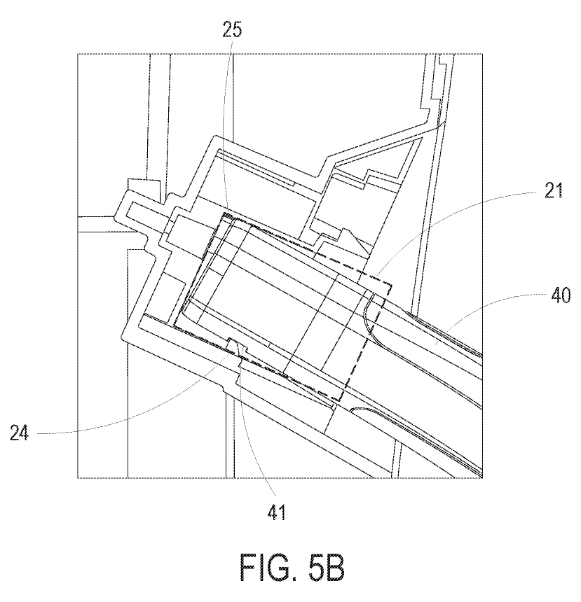

In an embodiment, as shown in FIG. 5A and FIG. 5B, the first standard vehicle charging connector is a NACS charging connector 40 and is received in the first passage 21. Since the NACS charging connector 40 has a circular column shape, the first passage 21 is correspondingly formed to be a cylindrical space, such as the first inner surface 211 encloses a cylindrical space. Moreover, since a first engaging portion 41, such as a recess, is located at the lower portion of the NACS charging connector 40, the first engaging element 24 is implemented as a protrusion located at the lower portion of the first passage 21 and extended into the first passage 21 so as to engage with the first engaging portion 41 when the NACS charging connector 40 is received therein. Moreover, for allowing the NACS charging connector 40 to be inserted without being blocked by the first engaging element 24, the sectional area of the first passage 21 perpendicular to the longitudinal thereof is implemented to be slightly larger than the sectional area of the NACS charging connector 40 perpendicular to the longitudinal thereof. Under this configuration, after the NACS charging connector 40 is inserted in the first passage 21 and the first engaging portion 41 is engaged with the first engaging element 24, due to the weight of the NACS charging connector 40 and also the slightly larger space of the first passage 21, the front end of the NACS charging connector 40 is tilted to move upward and against the upper portion of the first inner surface 211 of the first passage 21. Through which, engaging forces are formed at both the upper and lower portions of the NACS charging connector 40, thereby further ensuring the immobilization of the NACS charging connector 40 in the first passage 21. Moreover, a supporting element 25 can be further disposed at the upper portion of the first inner surface 211 of the first passage 21, opposite to the first engaging element 24, to press against the upwardly tilted front end of the NACS charging connector 40 for buffering, thereby achieving a more stable resting state of the NACS charging connector 40 in the first passage 21. For example, as shown in FIG. 2, the supporting element 25 is implemented as two bulges to press against the NACS charging connector 40 so as to cooperate with the first engaging element 24 to provide fixing forces for the NACS charging connector 40, but not limited thereto. The number and position of the supporting element 25 can be varied in accordance with the practical requirements.

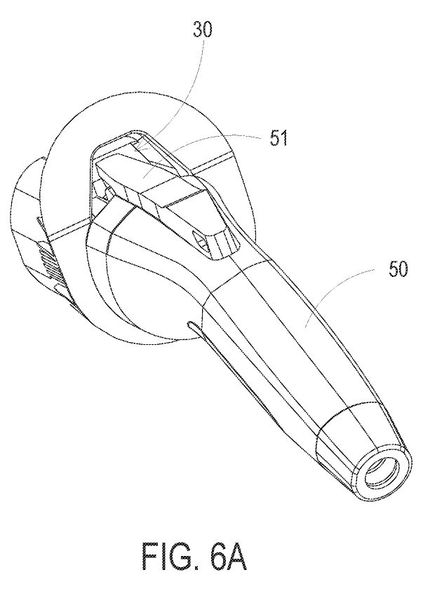

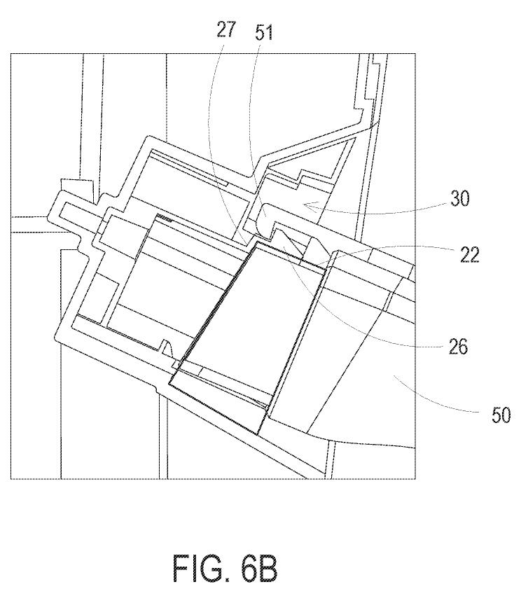

In an embodiment, as shown in FIG. 6A to FIG. 6B, the second standard vehicle charging connector is a Type 1 charging connector 50 and is received in the second passage 22. Compared with the NACS charging connector 40, the sectional area of the Type 1 charging connector 50 perpendicular to the longitudinal direction thereof is larger and the length thereof parallel to the longitudinal direction is shorter, so that the sectional area of the second passage 22 perpendicular to the longitudinal direction thereof is larger than that of the first passage 21, and the length of the second passage 22 parallel to the longitudinal direction thereof is shorter than that of the first passage 21, which therefore forms the step 27. In other words, the sectional area and the length of the second passage 22 are defined by the step 27 which is located at the intersection between the first inner surface 211 of the first passage 21 and the second inner surface 221 of the second passage 22, and also, the step 27 contributes to the positioning of the Type 1 charging connector 50 after entering the second passage 22.

As shown, the Type 1 charging connector 50 has a second engaging portion 51 at the upper portion thereof and extended outwardly, so that the second engaging element 26 is implemented to locate at the top of the periphery of the second passage 22 for engaging with the second engaging portion 51 when the Type 1 charging connector 50 is received therein. In this embodiment, a receiving space 30 adjacent to the accommodating space 20 is further formed in the base 10 for receiving the second engaging portion 51 when the Type 1 charging connector 50 enters the second passage 22. That is, the main portion of the Type 1 charging connector 50 is inserted into the second passage 22 while the second engaging portion 51 separately enters the receiving space 30. Accordingly, the second engaging element 26 at the top of the second passage 22 is implemented to extend into the receiving space 30, so as to engage with the second engaging portion 51 entering the receiving space 30. For example, in an embodiment, the second engaging portion 51 is implemented as a flexible plastic fastening piece and the second engaging element 26 is implemented as a protrusion having a corresponding shape, and when the Type 1 charging connector 50 is inserted into the second passage 22, the second engaging portion 51 which enters the receiving space 30 can be temporarily pushed up by the second engaging element 26 and then flipped back to engage therewith. Hence, the receiving space 30 also helps to provide space for the second engaging portion 51 to complete the engagement. Furthermore, since the second engaging portion 51 is separately received in the receiving space 30 and no engaging structure is disposed within the second passage 22, the sectional area of the second passage 22 perpendicular to the longitudinal direction thereof can be formed to be close to that of the main portion of the Type 1 charging connector 50, so as to increase the mechanical interference between the contour of the Type 1 charging connector 50 and the second inner surface 221 of the second passage 22, thereby achieving a more stable resting state of the Type 1 charging connector 50 in the second passage 22.

Notably, the sectional shape and the sectional area of the receiving space 30 can be varied in accordance with the structure of the second engaging portion 51 without limitation. For example, in some embodiments, the Type 1 charging connector 50 may include a cover (not shown) located on the top of the second engaging portion 51, and under this situation, the receiving space 30 can be varied to have a sectional shape corresponding to that of the cover, such as a trapezoid shape, a square shape or other suitable shapes, so as to increase the mechanical interference therebetween and improve the resting stability.

It should be noted that, although the drawings and descriptions of the first passage 21 and the second passage 22 are mainly based on the NACS charging connector 40 and the Type 1 charging connector 50, the present disclosure is not limited thereto. The first passage 21 and the second passage 22 can be designed in accordance with the contours of vehicle charging connectors of other standards to develop an accommodating space different from the described accommodating space 20 without escaping the scope of the present disclosure. Moreover, the implementations of the first engaging element 24 and the second engaging element 26 and the positions thereof respectively related to the first passage 21 and the second passage 22 also can be varied in accordance with the structures of the selected connectors, and the point is that fixations of respective vehicle charging connectors of different standards corresponding thereto can be achieved.

Besides, although the drawings and descriptions above are based on two passages for receiving vehicle charging connectors of two standards, it also can be designed to include more than two passages. For example, three passages can be included in the holder to receive vehicle charging connectors of three standards, and corresponding engaging elements can be disposed for engaging with these three vehicle charging connectors respectively.

In other words, as long that a holder capable of receiving plural vehicle charging connectors of different standards via one shared entrance through defining an overlapped portion of plural vehicle charging connectors, developing additional spaces for respective connectors around the overlapped portion and providing corresponding engaging elements, it falls within the scope of the present disclosure without being limited by the standards and contours of the vehicle charging connectors.

In conclusion, the holder for vehicle charging connector of the present disclosure provides the solution for adapting to vehicle charging connectors of different standards in one single structure design. The single accommodating space is designed to simultaneously match to the contours of vehicle charging connectors of different standards, and engaging elements corresponding to respective vehicle charging connectors are also disposed in the accommodating space, so that respective vehicle charging connectors can be inserted via one shared entrance and immobilized therein, thereby achieving the holder capable of receiving and fixing vehicle charging connectors of more than one standards in single structure design. Therefore, even the used vehicle charging connector is changed, for example, due to car change, the original holder still can be used to hold the vehicle charging connector of new standard, thereby effectively saving the cost and space for setting the holder.

While the disclosure has been described in terms of what is presently considered to be the most practical embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A holder for vehicle charging connector, comprising:
a base;
an accommodating space disposed within the base for receiving one of a first standard vehicle charging connector and a second standard vehicle charging connector, the accommodating space comprising:
a first passage for receiving the first standard vehicle charging connector; and
a second passage for receiving the second standard vehicle charging connector, the second passage overlapped with the first passage at least in part;
a first engaging element disposed around the first passage for engaging with the first standard vehicle charging connector; and
a second engaging element disposed around the second passage for engaging with the second standard vehicle charging connector.

2. The holder for vehicle charging connector as claimed in claim 1, wherein the first passage and the second passage have a same entrance.

3. The holder for vehicle charging connector as claimed in claim 1, wherein the accommodating space comprises a first inner surface and a second inner surface, the first inner surface defines at least one portion of the first passage, and the second inner surface defines at least one portion of the second passage.

4. The holder for vehicle charging connector as claimed in claim 3, wherein at least one portion of the first inner surface mechanically interferes with the first standard vehicle charging connector, and at least one portion of the second inner surface mechanically interferes with the second standard vehicle charging connector.

5. The holder for vehicle charging connector as claimed in claim 3, wherein a step is formed at an intersection between the first inner surface and the second inner surface, and the step defines a length of the second passage parallel to a longitudinal direction thereof.

6. The holder for vehicle charging connector as claimed in claim 1, wherein the first standard vehicle charging connector comprises a first engaging portion, and the first engaging element is extended into the first passage for engaging with the first engaging portion.

7. The holder for vehicle charging connector as claimed in claim 1, further comprising a supporting element disposed in the first passage and opposite to the first engaging element for pressing against the first standard vehicle charging connector.

8. The holder for vehicle charging connector as claimed in claim 1, further comprising a receiving space disposed within the base and adjacent to the accommodating space, wherein the second standard vehicle charging connector comprises a second engaging portion extended outwardly, and the second engaging portion is disposed in the receiving space when the second standard vehicle charging connector enters the second passage.

9. The holder for vehicle charging connector as claimed in claim 8, wherein the second engaging element is extended into the receiving space for engaging with the second engaging portion.

10. The holder for vehicle charging connector as claimed in claim 8, wherein the second standard vehicle charging connector comprises a cover located on a top of the second engaging portion, and a sectional area of the receiving space perpendicular to a longitudinal direction of the second passage is approximately identical to a contour of the cover.

11. A holder for vehicle charging connector, comprising:
a base;
an accommodating space disposed within the base for receiving vehicle charging connectors of a plurality of standards, the accommodating space comprising:
a plurality of passages, wherein each of the plurality of passages receives one corresponding vehicle charging connector of the vehicle charging connector of the plurality of standards, and the plurality of passages are overlapped at least in part; and
a plurality of engaging elements, wherein each of the plurality of engaging elements is disposed around one corresponding passage of the plurality of passages for engaging with one corresponding vehicle charging connector of the vehicle charging connectors of the plurality of standards received in the corresponding passage.

12. The holder for vehicle charging connector as claimed in claim 11, wherein the plurality of passages have a same entrance.
